(19) United States
(12) Patent Application Publication
(10) Pub. No.: US 2023/0303734 A1
(43) Pub. Date: Sep. 28, 2023

(54) PARTIALLY HYDROGENATED DIENE POLYMERS

(71) Applicant: ARLANXEO DEUTSCHLAND GMBH, Dormagen (DE)

(72) Inventors: Jiawen ZHOU, Dusseldorf (DE); Thomas RUENZI, Dusseldorf (DE); Ella KRIEMEN, Koln (DE); Wilfried BRAUBACH, Bergheim (DE)

(21) Appl. No.: 18/040,874

(22) PCT Filed: Sep. 27, 2021
(86) PCT No.: PCT/EP2021/076476

§ 371 Date: Feb. 7, 2023

(30) Foreign Application Priority Data
Sep. 28, 2020 (EP) 20198701.3

(51) Int. Cl. C08F 136/06; C08K 3/36; C08C 19/02

(52) U.S. Cl. CPC C08F 136/06; C08K 3/36; C08C 19/02

(57) ABSTRACT

A curable, partially hydrogenated butadiene polymer having a hydrogenation degree from 0.5 to 55% and having a total amount of butadiene-derived vinyl groups according to the general formula (I)

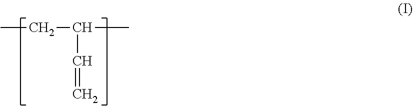

and trans groups of the general formula (II)

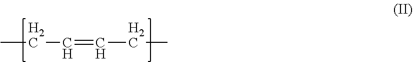

of from 0% to 9% by weight based on the total weight of the polymer and wherein the partially hydrogenated polybutadiene polymer is a butadiene polymer comprising at least 50% by weight based on the total weight of the polymer which is 100%, of units derived from 1,3-butadiene. Also provided are a process to make the polymer, compositions containing the polymer and articles obtained by using the polymer.

### BACKGROUND

Important properties of tires include good adhesion to dry and wet surfaces for safe driving, low rolling resistance for low fuel consumption and high abrasion resistance for extending the lifetime of the tire. It is challenging to improve the adhesion of a tire to wet surfaces without simultaneously increasing the rolling resistance or decreasing abrasion resistance. Adhesion to wet surfaces, also referred to as “wet slip resistance”, and rolling resistance largely depend on the dynamic mechanical properties of the rubber used for manufacturing the tire. Rubbers with high rebound elasticity at higher temperatures (60° C. to 100° C.) are advantageous for reducing rolling resistance while rubbers with a high damping factor or low rebound elasticity at low temperatures (0 to 23° C.) are advantageous for improving wet grip. Polybutadiene rubbers are known to have good dynamic mechanical properties and are widely used for making tires.

When polymerizing 1,3-butadiene, the resulting polymer contains repeating units having a carbon-carbon double bond. Depending on how the hydrogen atoms are distributed on this carbon-carbon double bond the repeating polymer units can be distinguished between vinyl units (generated by a 1,2 addition, also referred to in the art as “1,2 butadiene units”), cis units, and trans units. The latter two are generated by a 1,4-addition and are collectively referred to in the art as “1,4-butadiene units”.

The 1,2-butadiene units (vinyl units) have a pending double bond and can be represented by formula (I):

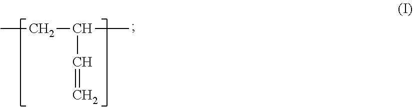

or, alternatively, by stereographic formula (IA):

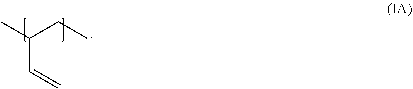

Formula (I) and (IA) are alternative representations of the same chemical unit.

In the cis-1,4-butadiene unit both —CH₂— groups bonded to the carbon-carbon double bond are distributed on the same side of the double bond. The cis-1,4-butadiene units (cis units) can be represented by formula (II):

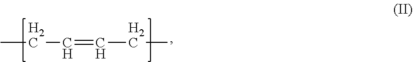

or, alternatively, by stereographic formula (IIA)

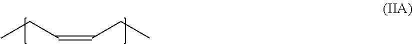

Formula (II) and (IIA) are two different ways of describing the same chemical unit.

In the trans-1,4-butadiene unit the two —CH₂— groups bonded to the carbon-carbon double bond are distributed on opposite sides of the double bond. The trans-1,4-butadiene units (trans units) can be represented by formula (III):

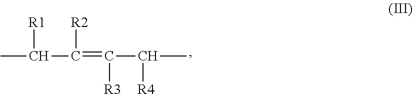

wherein R1, R2, R3 and R4 are all hydrogens. Alternatively, the trans-1,4-butadiene unit can be represented also by formula (IIIA)

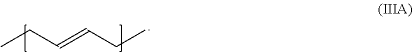

Formula (III) and (IIIA) are two different ways of describing the same chemical unit.

Depending on the polymerization process employed these different units can be generated in different amounts and the properties of the resulting polymers can be controlled.

Polybutadienes obtained by an anionic polymerization process using an alkali metal initiator, e.g. butyl lithium, lead to a random distribution of all three types of these units. Butadiene polymers obtained by this method tend to have a low content of cis units (between 10 to 30% by weight) and a medium to high content of trans and vinyl units in the polymer chain.

When using a polymerization catalyst based on a transition metal or a rare earth metal, the formation of the three different types of units can be controlled better. For example, polymers with a very low content of vinyl and trans units and a very high amount of at least 90% by weight of cis units can be obtained by using a polymerization catalyst based on one or more rare earth metals, or a polymerization catalyst based on cobalt, nickel or titanium.

The production of butadiene polymers with a high cis content (and thus low trans and vinyl content) is known. High cis-butadiene polymers are commercially readily available, for example under the trade designation BUNA from Arlanxeo Deutschland GmbH, Cologne, Germany.

While high cis-polybutadiene polymers are known to have good dynamic mechanical properties, they tend to have a comparatively low abrasion resistance. They are often combined with other polymers, typically butadiene-styrene copolymers or fillers to increase the abrasion resistance of the material.

Therefore, there is not only a continuous need to provide rubbers that can be compounded to produce tire materials with improved properties regarding rolling resistance and skip resistance. There is also a general need to improve the interactions of the rubber polymers with fillers. Good compatibility of butadiene rubbers with fillers are important to avoid phase separation over time, because phase separation may reduce the internal stability of the tire and its lifetime.

In US2016/0280815 A1 it was demonstrated that the dispersion of filler in a polybutadiene rubber matrix can be improved by functionalizing polybutadiene polymers with polar groups as was demonstrated by an increased Payne index. The Paine index is a measure for the homogeneous distribution of filler in a rubber matrix.

Surprisingly, it has been now found that the compatibility of butadiene polymers with fillers can be improved through partial hydrogenation of the butadiene polymers at low hydrogenation degrees. Hydrogenation is believed to reduce the polarity of the polymer because it reduces the number of unsaturated double bonds. The partially hydrogenated butadiene rubbers are also easy to process into tires or components thereof because they show good or improved dynamic mechanical properties already at a low degree of hydrogenation and thus at a low Mooney viscosity.

### SUMMARY

Therefore, in the following there is provided a curable, partially hydrogenated butadiene polymer having a hydrogenation degree from 0.5 to 55%, preferably from 2 to 39%, and having a total amount of butadiene-derived vinyl groups according to the general formula (I)

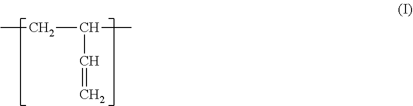

and trans groups of the general formula (II)

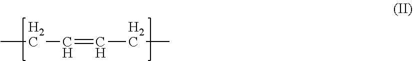

of 0 to 9% by weight based on the total weight of the polymer and wherein the partially hydrogenated polybutadiene polymer is a butadiene polymer comprising at least 50% by weight based on the total weight of the polymer of units derived from 1,3-butadiene.

In another aspect there is provided a composition comprising from 90% to 100% by weight based on the total weight of the composition of at least one partially hydrogenated butadiene polymer.

In a further aspect there is provided a curable compound comprising at least 10% by weight based on the total weight of the compound of the partially hydrogenated butadiene polymer and further comprising at least one filler or at least one curing agent capable of curing the partially hydrogenated butadiene polymer or a combination thereof, and wherein the filler is suitable for application in tires, tire components and materials for making tires and preferably contains one or more silicon oxide, one or more carbon blacks or a combination of one or more silicon oxide and one or more carbon black.

In yet another aspect there is provided a vulcanizate obtained by curing the curable compound.

In a further aspect there is provided an article comprising the vulcanizate.

In another aspect there is provided a process of making the partially hydrogenated butadiene polymer comprising providing at least one curable butadiene polymer as starting polymer and subjecting the starting polymer to at least one hydrogenation treatment to reduce the number of unsaturated units in the polymer and to achieve a hydrogenation degree from 0.5% to 55% and an amount of butadiene-derived vinyl groups according to the general formula (I)

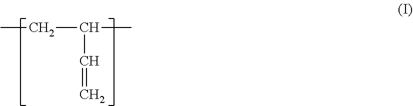

and butadiene-derived trans groups of the general formula (II)

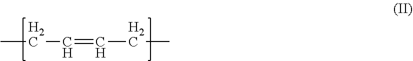

of 0% to 9.0% by weight based on the total weight of the polymer, wherein the starting polymer contains at least 50% by weight, preferably at least 80% by weight of units derived from 1,3-butadiene.

In a further aspect there is provided a process of making an article comprising subjecting the curable rubber compound to curing and shaping wherein the shaping may take place during or after or prior to the curing.

### DETAILED DESCRIPTION

The present disclosure will be further illustrated in the following detailed description.

In the following description certain standards (ASTM, DIN, ISO etc.) may be referred to. If not indicated otherwise, the standards are used in the version that was in force on Mar. 1, 2020. If no version was in force at that date because, for example, the standard has expired, then the version is referred to that was in force at a date that is closest to Mar. 1, 2020.

All documents recited in this description are incorporated by reference, unless indicated otherwise.

In the following description the amounts of ingredients of a composition or a polymer may be indicated interchangeably by “weight percent”, “wt. %” or “% by weight”. The terms “weight percent”, “wt. %” or “% by weight” are based on the total weight of the composition or polymer, respectively, which is 100% unless indicated otherwise.

The term “phr” means “parts by weight per hundred parts by weight of rubber”. This term is used in rubber compounding to base the amounts of ingredients of a rubber composition on the total amount of rubber in the rubber compound. The amount of one or more ingredients of a composition (parts by weight of the one or more ingredient) are based on 100 parts by weight of rubber.

Ranges identified in this disclosure are meant to include and disclose all values between the endpoints of the range and its end points, unless stated otherwise.

The term “comprising” is used in an open, non-limiting meaning. The phrase “a composition comprising ingredients A and B” is meant to include ingredients A and B but the composition may also have other ingredients. Contrary to the use of “comprising” the word “consisting” is used in a narrow, limiting meaning. The phrase “a composition consisting of ingredients A and B” is meant to describe a composition of ingredients A and B and no other ingredients.

Butadiene polymers:

Typically, the partially hydrogenated polymers according to the present disclosure are rubbers.

Rubbers typically have a glass transition temperature below 20° C.

The partially hydrogenated butadiene polymers according to the present disclosure are curable. They may be obtained by providing a curable butadiene polymer as starting polymer and subjecting the starting polymer to hydrogenation to reduce the number of unsaturated units in the polymer and to achieve a hydrogenation degree from 0.5 to 55%, for example from 2 to 39%. In one embodiment of the present disclosure the partially hydrogenated polymer has a hydrogenation degree of from 7% to 39%. In one embodiment of the present disclosure the partially hydrogenated polymer has a hydrogenation degree of from 12% to 39%. Articles produced with the partially hydrogenated butadiene rubbers, typically contain the rubbers in their cured form.

The butadiene polymers according to the present disclosure include homopolymers and copolymers of 1,3-butadiene. Preferably, the polymers according to the present disclosure contain at least 50%, preferably at least 80% by weight, based on the weight of the polymer, of units derived from 1,3-butadiene. In one embodiment of the present disclosure the partially hydrogenated polymers contain at least 90% by weight, or 95% by weight or even at least 99% by weight of units derived from 1,3-butadiene.

In one embodiment of the present disclosure the partially hydrogenated polymers contain from 0% to 50% by weight, preferably from 0% to 20% by weight, based on the total weight of the polymer, of one or more comonomers.

Suitable comonomers include, but are not limited to, conjugated dienes having from 5 to 24, preferably from 5 to 20 carbon atoms. Specific examples include but are not limited to isoprene, 1,3-pentadiene, 2,3-dimethylbutadiene, 1-phenyl-1,3-butadiene, 1,3-hexadiene, myrcene, ocimene, farnesene and combinations thereof. The comonomers may be functionalized at one or more positions to provide other functionalities other than carbon-hydrogen bonds. Such other functionalities may include cross-linking sites, branching sites, branches or functionalized end groups.

Suitable comonomers also include, but are not limited to, one or more other co-polymerizable comonomers, including for example comonomers that introduce functional groups including cross-linking sites, branching sites, branches or functionalized end groups.

Combinations of one or more of the comonomers of the same chemical type as described above as well as combinations of one or more comonomers from different chemicals types may be used.

In one embodiment of the present disclosure the partially hydrogenated butadiene polymer contains from 0 to 10% by weight of units derived from one or more comonomers, preferably from 0 to 5% by weight and more preferably less than 1% by weight (based on the total weight of the polymer).

In one embodiment of the present disclosure the partially hydrogenated polymer contains no or essentially no units derived from one or more vinyl aromatic comonomers, and, in particular essentially no units derived from styrene, o-methylstyrene, m-methylstyrene, p-methylstyrene, p-tert-butylstyrene, vinyl naphthalene, divinylbenzene, trivinylbenzene, divinylnaphthalene. “Essentially no” as used herein means less than 1% by weight and preferably less than 0.1% by weight based on the total weight of the polymer.

In one embodiment of the present disclosure the partially hydrogenated butadiene polymer contains no or essentially no units derived from one or more alpha-olefins, and in particular no or essentially no units derived from ethene, propene, 1-butene, 1-pentene, 1-hexene, 4-methyl-1-pentene,1-octene and combinations thereof.

In the partially hydrogenated polymers according to the present disclosure the units derived from the one or more comonomers may or may not have been affected by the hydrogenation.

Partially hydrogenated butadiene polymers according to the present disclosure have a low amount of butadiene-derived vinyl groups (1,2-butadiene units) according to formula (I)

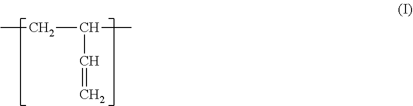

and butadiene-derived trans groups (1,4-butadiene units) according to formula (II)

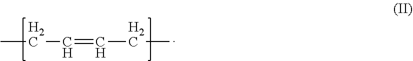

Preferably, the partially hydrogenated butadiene polymers have a total amount of such trans and vinyl units of less than 9% by weight based on the total weight of the polymer, preferably less than 5% by weight and including 0%.

Preferably, the partially hydrogenated butadiene polymers have a total amount of such vinyl groups of 0.94% by weight based on the total weight of the polymer or less than 0.94% by weight and including 0%. Typical amounts include from 0% to 0.90% by weight or from 0 to 0.8% by weight based on the total weight of the polymer.

Preferably, the partially hydrogenated butadiene polymers according to the present disclosure have from 0 to 8% by weight of trans units (1,4 trans butadiene units) according to the general formula (II), preferably from 0 to 4% by weight or even from 0 to 2% by weight.

The partially hydrogenated polybutadiene polymers according to the present disclosure may have a Mooney viscosity ML 1+4 at 100° C. of from 40 to 130 Mooney units, for example from 55 to 130 or from 60 to 129 units.

Partially hydrogenated polybutadiene polymers according to the present disclosure may have a weight-averaged molecular weight (Mw) of from 100,000 g/mole to 2,500,000 g/mole. In one embodiment the polymers have an Mw of from 450 kg/mole to 620 kg/mole.

Partially hydrogenated polybutadiene polymers according to the present disclosure may have a molecular weight distribution (MWD), from 1.5 to 15. In one embodiment of the present disclosure the polymers have an MWD of from 1.5 to 4.5.

Partially hydrogenated polybutadiene polymers according to the present disclosure may have a glass transition temperature (Tg) of from −120° C. to 0° C. In a preferred embodiment of the present disclosure the polymers have a Tg of from −60° C. to −110° C. or from −65° C. to −105° C.

In one embodiment the partially hydrogenated polybutadiene polymers according to the present disclosure have a Mooney viscosity ML 1+4 at 100° C. of from 40 to 130 units, a molecular weight of from 100,000 to 2,500,000 g/mole, a molecular weight distribution (MWD) from 1 to 20 and a glass transition temperature of from −120° C. to 0° C.

In one embodiment of the present disclosure the partially hydrogenated polymers of the present disclosure have a Mooney stress relaxation (MSR) of 0.6 or less, for example from 0.3 to 0.59.

In a preferred embodiment the partially hydrogenated polymers of the present disclosure contain sulfur bound to the polymer, for example as the result of a treatment with a sulfur-containing modifier. Preferably, the polymer has a content of bound sulfur as measured by extraction of from 12 ppm to 20,000 ppm or from 20 ppm to 2,000 ppm based on the total weight of the polymer.

### Process of Making Partially Hydrogenated Butadiene Polymers

The partially hydrogenated butadiene polymers according to the present disclosure are obtainable by subjecting at least one butadiene starting polymer to at least one hydrogenation treatment to reduce the number of unsaturated units in the polymer. Preferably the hydrogenation treatment is carried out to achieve a hydrogenation degree as described above. The hydrogenation treatment may include a single treatment or multiple treatments.

The starting polymer typically is a butadiene homopolymer or a butadiene copolymer with comonomers described above for the partially hydrogenated polymers. Typically, the starting 20 polymer contains at least 50% by weight, preferably at least 80% by weight of units derived from 1,3-butadiene. In one embodiment of the present disclosure the starting polymer contains at least 90% by weight, or 95% by weight or even at least 99% by weight of units derived from 1,3-butadiene.

Typically, the starting polymer is a non-hydrogenated butadiene polymer. However, the hydrogenation treatment may be carried out stepwise and may comprise of more than one treatment step. A partially hydrogenated butadiene may also be used as starting polymer and its hydrogenation degree is then further increased by the hydrogenation treatment. The hydrogenation treatment comprises treating the polymer with hydrogen, typically under pressure and typically comprising the use of one or more hydrogenation catalysts. Hydrogen atoms are added to the carbon-carbon double bonds of the polymer converting them into saturated carbon-carbon bonds. Preferably a polymer with high amounts of butadiene-derived cis units (and consequently low amounts of trans and vinyl units) is used as starting polymer. Preferably, the starting butadiene polymer has at least 90% by weight of butadiene-derived cis units according to formula (III):

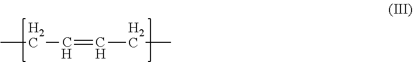

Preferably, the starting butadiene polymer has at least 91% by weight or at least 92% by weight based on the total weight of the polymer of such cis units. The number of cis units will be reduced by the hydrogenation treatment because a fraction of the cis units will be hydrogenated and converted to saturated groups according to formula (IV):

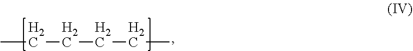

or according to the alternative, stereographic representation in formula (IVA):

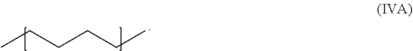

Formula (IV) and (IVA) are different representations of the same chemical unit.

The number of butadiene-derived vinyl and butadiene-derived trans groups may or may not be reduced by the hydrogenation treatment. Therefore, the hydrogenation treatment may be carried out to keep or to reduce the amount of butadiene-derived vinyl groups, trans groups or both. In one embodiment the starting polybutadiene polymer according to the present disclosure is subjected to a hydrogenation treatment to keep or to reduce the amount of butadiene-derived vinyl and trans groups to provide a partially hydrogenated butadiene polymer with the total and individual amounts of vinyl groups according to formula (I) and trans groups of formula (II) as described above for the partially hydrogenated butadiene polymer.

In one embodiment of the present disclosure the starting butadiene polymer has a total amount of vinyl groups according to formula (I) and trans groups of formula (II) of 9% by weight or less. In one embodiment of the present disclosure the starting polymer has a total amount of such vinyl groups of 0.94% by weight based on the total weight of the polymer or less than 0.94% by weight and including 0%. Typical amounts include from 0% to 0.90% by weight or from 0.5 to 0.8% by weight based on the total weight of the polymer.

In one embodiment of the present disclosure the starting butadiene polymer has from 0% to 8% by weight based on the total weight of the polymer % of trans units (1,4 trans butadiene units) according to the general formula (II).

In one embodiment of the present disclosure the hydrogenation is also carried out to increase the Mooney viscosity of the starting polymer and to provide a partially hydrogenated polymer according to the present disclosure having a Mooney viscosity of ML 1+4 at 100° C. of from 40 to 130 Mooney units, for example 55 to 130 or from 60 to 129 units.

In one embodiment of the present disclosure the hydrogenation is also carried out to provide a partially hydrogenated polybutadiene polymer having a weight-averaged molecular weight (Mw) of from 100,000 g/mole to 2,500,000 g/mole.

In one embodiment of the present disclosure the hydrogenation is also carried out to increase the molecular weight distribution (MWD) of the starting polymer to provide a partially hydrogenated polybutadiene polymer having an MWD of from 1.0 to 20, for example from 1.5 to 4.5.

In one embodiment of the present disclosure the hydrogenation is also carried out to reduce the glass transition temperature of the starting polymer to provide a partially hydrogenated polybutadiene polymer having a glass transition temperature (Tg) of from −120° C. to 0° C., preferably from −60° C. to −110° C. or from −65° C. to −105° C.

The starting butadiene polymers used for making curable, partially hydrogenated butadiene polymers according to the present disclosure can be prepared by known processes for making butadiene rubbers. Commercially available polymers may be used also. Suitable polymers can be prepared by using nickel, cobalt, titanium catalysts, or rare earth catalysts. Rare earth catalysts include neodymium; praseodymium, cerium, lanthanum, gadolinium and dysprosium or a combination thereof. In a more preferred embodiment, the rare earth element comprises neodymium. Suitable polymers can be prepared as described, for example, in Canadian patent application CA 1,143,711 A, U.S. Pat. No. 4,260,707, US patent application No US2013/0172489 A1 or as described in paragraphs [0011] to [0049] of EP 2 819 853 Al, all incorporated herein by reference.

For example, the butadiene monomer (and comonomers if present) can be polymerized in an inert solvent and in the presence at least one catalyst composition, containing Ti, Co, Ni, or a rare earth metal. In a preferred embodiment the starting butadiene polymer is prepared by using a polymerization catalyst comprising a rare earth metal, preferably neodymium. Such rare-earth-catalyzed butadiene polymers preferably comprise more than 92 wt. % of cis-1,4 units and less than 1 wt. % of 1,2-vinyl units and less than 8% by weight of 1,4-trans units (percentages based on the total weight of the polymer). In one embodiment the starting butadiene polymer has a content of vinyl groups of from 0.5 wt. % to 0.9 wt. %, or from 0.6 wt. % to 0.8 wt. %. In one embodiment the starting polymer has a content of 1,4 trans units of from 0.5 to 7.5% by weight based on the total weight of the polymer. Preferably the starting butadiene polymer is prepared by using a Ziegler-Natta type rare earth, preferably. neodymium, catalyst composition. Typically, a Ziegler-Natta type catalyst system contains at least three components: a rare earth metal (e.g. neodymium) source, a chloride source and an organo aluminum compound.

The metal source may include an alkoxide, phosphate or carboxylate of the catalyst metal, (e.g. neodymium) and preferably is selected from neodymium versatate. Examples of chloride sources include but are not limited to alkyl aluminum chlorides, preferably ethyl aluminum sesquichloride. Organo aluminum compounds include alkyl aluminums, for example but not limited to, diisobutyl aluminum hydride (DIBAH). Typical reaction temperatures are between 60° C. and 140° C. Suitable inert solvents include, for example, aromatic, aliphatic and cycloaliphatic hydrocarbons. Examples include but are not limited to benzene, toluene, pentane, n-hexane, isohexane, heptane, isomeric pentanes, methyl cyclopentane and cyclohexane. The solvents may be used individually or in combination or blended with one or more polar solvents. The inert organic solvents may be used in amounts of 200 to 900 parts by weight based on 100 parts by weight of monomers. The polymerization may be carried out continuously or batchwise. The reaction can be stopped, for example, by deactivating the catalyst, for example by adding a protic compound.

The polybutadiene starting polymer may or may not be treated with one or more modifiers, preferably sulfur-containing modifiers, to introduce branches or links with other polymer chains, for example to increase the Mooney viscosity or to reduce the Mooney stress relaxation. The use of modifiers for that purpose as is known in the art and is described, for example, in US patent numbers U.S. Pat. Nos. 9,845,366, 9,963,519 and 5,567,784. In one embodiment of the present disclosure the polybutadiene starting polymer has been treated with one or more modifying agents, preferably one or more modifying agents containing sulfur or one or more sulfur groups. The treatment with a sulfur-containing modifier may lead to the incorporation of sulfur into the polymer and to the creation of sulfur-carbon bonds in the polymer. The amount of sulfur bonded to the polymer may be determined by determining the sulfur content of the polymer after extraction. Typically, the starting polymer may have a content of bound sulfur (measured after extraction) of from about 12 ppm to about 20,000 ppm, preferably from about 20 ppm to about 2,000 ppm based on the total weight of the polymer.

The modification treatment to increase the Mooney viscosity or to reduce the Mooney stress relaxation or to introduce branches in the polymer may be carried out, preferably, in the reaction mixture after the polymerization was stopped and, preferably, before the work up procedure. Preferably, the treatment is carried out in the reaction mixture. Suitable sulfur-containing modifiers include sulfur halides, more preferably sulfur bromides and sulfur chlorides and polysulfur halides. Preferably, the sulfur-containing modifiers have between 1 to 8 sulfur atoms per molecule, preferably one or two sulfur atoms per molecule. Suitable examples include but are not limited to S₂Cl₂, SCl₂, SOCl₂, S₂Br₂, SOBr₂. Typical amounts of modifying agents may include from 0.005 to 2 parts by weight per hundred parts of starting polymer or from 0.007 to 0.5 parts per hundred parts of starting polymer.

It is contemplated that also functionalized modifying agents containing a functional group R other than or in addition to sulfur or halide may be used, also. Examples of such modifying agents are described in US2016/0280815 A1 or European Patent EP 2 819 853 B1 both incorporated herein by reference in their entirety. However, such functional groups may be affected by the hydrogenation, which may be undesired.

In one embodiment of the present disclosure the starting polymer has a Mooney stress relaxation (MSR) of 0.6 or less, for example from 0.3 to 0.59, for example but necessarily, as a result of treatment with a modifying agent.

In one embodiment of the present disclosure the starting polymer has a Mooney stress relaxation (MSR) of more than 0.6.

In one embodiment of the present disclosure the starting polymer has not been treated with a modifying agent described above, for example a modifying agent containing sulfur, or one or more sulfur halides or one or more sulfur halide compounds further containing one or more functional groups R other than sulfur and halide. Such starting polymer may contain no amounts of sulfur after extraction, or less than 0.005% by weight, or less than 30 ppm of sulfur (based on the total weight of the polymer of sulfur).

The hydrogenation of the starting polymer can be carried out as known in the art for hydrogenating diene polymers. Examples of hydrogenation methods are described, for instance, in U.S. Pat. Nos. 5,017,660, 5,334,566, 7,176,262 B2, 10,364,335 B2 and U.S. 2019/0284374 A1. Preferably, the hydrogenation is done by using a Wilkinson's catalyst (RhCI(PPh₃)₃). The “Procedure for Hydrogenations” described in the experimental section of 35 U.S. patent application No. U.S. 2019/0284374 A1 to Salem et al, can be essentially followed.

Although this reference describes the hydrogenation of acrylonitrile rubbers, it can be applied generally also to polybutadienes.

The hydrogenation of the starting polymer may be done in the reaction mixture or with the isolated polymer, preferably dissolved or suspended in a solvent for the hydrogenation, which may be a different solvent than used in the polymerization. A typical solvent includes chlorobenzene. Typically, the polymer may be dissolved in the solvent in amounts of from 5% to 15% by weight.

Preferably, the hydrogenation catalyst is a Wilkinson's catalyst. The amount of catalyst may depend on the hydrogenation degree to be achieved and may include amounts from 0.02 to 0.08 phr. Hydrogen may be added typically at a pressure of 1.5 to 100 bar. Stirrer speed, for example in a 10-liter, high-pressure vessel may be, typically, from 500 to 1000 rpm. The reaction may be carried out over several hours for example between 1 to 24 hours.

The partially hydrogenated polymer can be worked up as known in the art. The hydrogenation reaction may be terminated, for example, by releasing the hydrogen pressure and addition of stabilizers. The polymers may be isolated by evaporating the solvent, precipitation by adding appropriate amounts of one or more polar liquids (for example, methanol, ethanol, acetone), or preferably by steam stripping. Water can be removed by suitable sieves or screw assemblies such as expeller or expander screws or fluidized-bed dryers. Further drying can be carried out in a conventional manner, for example in a drying cabinet or in a screw dryer.

### Polymer Compositions

The diene polymers according to the present disclosure are curable, i.e. the polymers can be cross-linked, for example by reaction or activation of one or more curing agents, for example for producing a “vulcanizate”, i.e. a cross-linked rubber product. However, the partially hydrogenated polymers according to the present disclosure may also be cross-linked to some extent such that they can still be cross-linked further.

In one aspect of the present disclosure there is provided a composition comprising at least one partially hydrogenated polybutadiene of the present disclosure. The compositions may further contain rubber auxiliaries as will be described below, or, one or more curing agent, or other ingredients and combinations thereof.

In one embodiment such a composition comprises at least 90% by weight, preferably at least 96% by weight, based on the total weight of the composition, of partially hydrogenated butadiene polymers according to the present disclosure. Such a composition may be, for example, in the form of a powder, in the form of granules, extruded pellets, sheets or bales. In one embodiment the composition containing at least 90% by weight, or at least 96% by weight, of partially hydrogenated polymer may have a Mooney viscosity ML 1+4 at 100° C. of from 40 to 130 Mooney units, for example from 55 to 130 or from 60 to 129 units. The composition may contain no extender oil or less than 10%, preferably less than 5% of extender oil (percent by weight based on the total amount of the composition). In one embodiment the composition is free of curing agents or contains curing agents in an amount of less than 10%, preferably less than 5% or even less than 1% by weight.

### Compounds

The compositions containing at least one partially hydrogenated polybutadiene polymer according to the present disclosure can be used for making rubber compounds. Therefore, in another aspect of the present disclosure there are provided rubber compounds containing at least one partially hydrogenated butadiene polymer according to the present disclosure, preferably in an amount of at least 5% by weight based on the weight of the compound. The rubber compounds may typically contain from 5% to 75%, or from 7 to 50% by weight based on the total weight of the compound of at least one partially hydrogenated butadiene polymer of the present disclosure.

Rubber compounds may additionally contain at least one filler. A rubber compound according to the present disclosure may contain at least 10% by weight, preferably at least 15% by weight, based on the weight of the compound, of one or more filler.

The rubber compounds may be, for example, in the form of a powder, in the form of granules, extruded pellets, sheets or bales. Such rubber compounds may further contain one or more rubber auxiliaries as will be described below, one or more curing agent, and/or one or more rubber other than the hydrogenated butadiene polymer.

### Filler

Preferably, the compound comprises at least one filler that is suitable for application in tires, tire components and materials for making tires. Preferably, the filler contains one or more silicon oxide, one or more carbon blacks or a combination of one or more silicon oxide and one or more carbon black. Preferably, the filler includes silica-containing particles, preferably having a BET surface area (nitrogen absorption) of from 5 to 1,000, preferably from 20 to 400 m²/g. Such fillers may be obtained, for example, by precipitation from solutions of silicates or by flame hydrolysis of silicon halides. Silica filler particles may have particle sizes of 10 to 400 nm. The silica-containing filler may also contain oxides of Al, Mg, Ca, Ba, Zn, Zr or Ti. Other examples of silicon-oxide based fillers include aluminum silicates, alkaline earth metal silicates such as magnesium silicates or calcium silicates, preferably with BET surface areas of 20 to 400 m²/g and primary particle diameters of 10 to 400 nm, natural silicates, such as kaolin and other naturally occurring silicates including clay (layered silicas). Further examples of fillers include glass particle-based fillers like glass beads, microspheres, glass fibers and glass fiber products (mats, strands).

Polar fillers, like silica-containing fillers may be modified to make them more hydrophobic. Suitable modification agents include silanes or silane-based compounds. Typical examples of such modifying agents include, but are not limited to compounds corresponding to the general formula (V):

(R¹R²R³O)₃Si—R⁴—X (V)

wherein each R¹, R², R³ is, independently from each other, an alkyl group, preferably R¹, R², R₃ are all methyl or all ethyl, R⁴ is an aliphatic or aromatic linking group with 1 to 20 carbon atoms and X is sulfur-containing functional group and is selected from —SH, —SCN, —C(═O)S or a polysulfide group.

Instead of or in addition to silicas that have been modified as described such modification may also take place in situ, for example during compounding or during the process of making tires or components thereof, for example by adding modifiers, preferably silanes or silane-based modifiers, for example including those according to formula (V), when making the rubber compounds.

Filler based on metal oxides other than silicon oxides include but are not limited to zinc oxides, calcium oxides, magnesium oxides, aluminum oxides and combinations thereof. Other fillers include metal carbonates, such as magnesium carbonates, calcium carbonates, zinc carbonates and combinations thereof, metal hydroxides, e.g. aluminum hydroxide, magnesium hydroxide and combinations thereof, salts of alpha-beta-unsaturated fatty acids and acrylic or methacrylic acids having from 3 to 8 carbon atoms including zinc acrylates, zinc diacrylates, zinc methacrylates, zinc dimethacrylates and mixtures thereof.

In another embodiment of the present disclosure the rubber compound contains one or more fillers based on carbon, for example one or more carbon black. The carbon blacks may be produced, for example, by the lamp-black process, the furnace-black process or the gas-black process. Preferably, the carbon back has a BET surface area (nitrogen absorption) of 20 to 200 m²/g. Suitable examples include but are not limited to SAF, ISAF, HAF, FEF and GPF blacks.

Other examples of suitable filler include carbon-silica dual-phase filler, lignin or lignin-based materials, starch or starch-based materials and combinations thereof.

In a preferred embodiment, the filler comprises one or more silicon oxide, carbon black or a combination thereof.

Typical amounts of filler include from 5 to 200 parts per hundred parts of rubber, for example, from 10 to 150 parts by weight, or from 10 to 95 parts by weight for 100 parts by weight of rubber.

### Curing Agents

Preferably the rubber compounds also contain at least one curing agent for curing the partially hydrogenated butadiene polymer. The curing agent is capable of crosslinking (curing) the partially hydrogenated butadiene polymer and is also referred to herein as “crosslinkers” or “vulcanization agent”. Suitable curing agents include, but are not limited to, sulfur, sulfur-based compounds, and organic or inorganic peroxides. In a preferred embodiment the curing agent includes a sulfur. Instead of a single curing agent a combination of one or more curing agents may be used, or a combination of one or more curing agent with one or more curing accelerator or curing catalysts may be used. Examples of sulfur-containing compounds acting as sulfur-donors include but are not limited to sulfur, sulfur halides, dithiodimorpholine (DTDM), tetramethylthiuramdisulphide (TMTD), tetraethylthiuramdisulphide (TETD), and dipentamethylenthiuramtetrasulphide (DPTT). Examples of sulfur accelerators include but are not limited to amine derivates, guanidine derivates, aldehydeamine condensation products, thiazoles, thiuram sulphides, dithiocarbamates and thiophospahtes. Examples of peroxides used as vulcanizing agents include but are not limited to di-tert.-butyl-peroxides, di-(tert.-butyl-peroxy-trimethyl-cyclohexane), di-(tert.-butyl-peroxy-isopropyl-)benzene, dichloro-benzoylperoxide, dicumylperoxides, tert.-butyl-cumyl-peroxide, dimethyl-di(tert.-butyl-peroxy)hexane and dimethyl-di(tert.-butyl-peroxy)hexine and butyl-di(tert.-butyl-peroxy)valerate. A vulcanizing accelerator of sulfene amide-type, guanidine-type, or thiuram-type can be used together with a vulcanizing agent as required.

If added, the vulcanizing agent is typically present in an amount of from 0.5 to 10 parts by weight, preferably of from 1 to 6 parts by weight per 100 parts by weight of rubber.

### Other Rubbers

The rubber compounds and compositions according to the present disclosure may contain one r more additional rubber other than the partially hydrogenated butadiene polymers of the present disclosure. Examples of such other rubbers include but are not limited to high-vinyl polybutadienes (i.e. vinyl content of at least 10% by weight), copolymers of butadiene with C1-C4-alkyl acrylates, chloroprenes, polyisoprenes, styrene-butadiene copolymers, isobutylene-isoprene copolymers, butadiene-acrylonitrile copolymers, including those having an acrylonitrile content of from 5 wt. % to 80 wt. %, for example those with an acrylonitrile content of from 10 wt. % to 40 wt. %; partially or fully hydrogenated acrylonitrile rubber, ethylene-propylene-diene copolymers, natural rubber and combinations thereof. Typical amounts of the one or more other rubbers in the compound may include, for example, from 5 to 500 parts per hundred parts of the partially hydrogenated butadiene polymer.

In one embodiment of the present disclosure the rubber compound contains one or more of the following rubbers: at least one natural rubber, at least one polybutadiene rubber having a vinyl content of greater than 1 and up to 75 wt. % based on the weight of the polymers. at least one styrene-butadiene copolymer, preferably having a glass transition temperature above −50° C. and preferably having a styrene content of from about 1% by weight to 60% by weight, preferably from 20 to 50% by weight, and combinations thereof. The rubbers may or may not be modified, for example, with silyl ethers or with other functional groups.

In a preferred embodiment of the present disclosure the rubber compound contains at least one styrene-butadiene copolymer, preferably in an amount of from 5% to 65% by weight, or from 10% to 50% by weight based on the total weight of the compound. Preferably, the rubber compound comprises in addition at least one filler comprising one or more silicon oxide, preferably in an amount of from 5 to 50% by weight based on the total weight of the compound.

In another embodiment of the present disclosure the diene polymers according to the present disclosure are combined with one or more diene polymer, preferably a polymer comprising units derived from butadiene and at least one vinyl aromatic compound as described above, preferably a styrene and that has one or more than one functional group comprising one or more than one atom selected from Si, O, N and S atoms, preferably the functional group comprises Si and O atoms. The functional group may be situated at the terminal position of the polymer in case of a-, co- or a- and o-functionalization as described, for example, in international patent application WO2021/009156 A1; U.S. patent applications U.S. 2016/0083495 A1 and US2016/0075809 A1, and in European patent application EP 2847264 A1, all incorporated herein by reference. The functional group may also be a pending group, e.g. as part of an in-chain-functional group, for example by treatment with mercapto acids, or mercapto polyethers as described, for example, in U.S. Pat. No. 6,521,698 B2, incorporated herein by reference.

It has been found that such blends may improve filler dispersion, in particular of silica and/or carbon fillers, as evidenced by improved mechanical or dynamic properties or both.

It has also been found that when using the polymers according to the present disclosure in combination with other diene polymers, functionalized or non-functionalized, the amounts of curatives needed to achieve certain mechanical or dynamic properties can be reduced—compared to blends using the non-hydrogenated counterparts. A combination of hydrogenated diene polymers according to the present disclosure and other diene polymers, in particular styrene-butadiene type polymers, has also been found to improve the abrasion resistance of tire compositions. Therefore, in one embodiment of the present disclosure there is provided a composition comprising a combination, for example a blend, of the partially hydrogenated butadiene polymer according to the present disclosure and at least one further diene polymer, preferably a polymer comprising units derived from butadiene and styrene, that is functionalized to comprise one or more terminal or side chain groups comprising one, or more than one, Si atom, N atom, S atom, O-atom, and preferably comprises a combination of one or more Si atoms and O atoms. For example, the functionalized polymer may be modified to comprise functional groups comprising one or more silanes, siloxanes, aminosiloxanes, sulfosiloxanes or combinations thereof. Such blends may comprise from 10% to 95% by weight based on the total weight of the blend, of one or more polymer according to the present disclosure and one or more functionalized polymer. Suitable weight ratios of polymers according to the present disclosure to functionalized polymers include weight ratios from 1:5 to 5:1. Such blends can be used to make rubber compounds as described above and below and articles as described above and below.

### Other Rubber Auxiliaries

The compositions and rubber compounds containing the partially hydrogenated butadiene polymers according to the present disclosure may contain one or more further rubber auxiliaries as known in the art of rubber compounding and processing. Such further auxiliaries include but are not limited to curing reaction accelerators, antioxidants, heat stabilizers, light stabilizers, processing aids, plasticizers, tackifiers, blowing agents and colorants. Processing aids include organic acids, waxes and processing oils. Examples of oils include but are not limited to MES (Mild Extraction Solvate), TDAE (Treated Distillate Aromatic Extract), RAE (Residual Aromatic Extract) and light and heavy naphthenic oils and vegetable oils. Specific examples of commercial oils include those with the trade designations Nytex 4700, Nytex 8450, Nytex 5450, Nytex 832, Tufflo 2000, and Tufflo 1200. Examples of oils include functionalized oils, particularly epoxidized or hydroxylated oils.

Activators include triethanolamine, polyethylene glycol, hexanetriol. Colorants include dyes and pigments and may be organic or inorganic and include, for example, zinc white and titanium oxides.

The further rubber auxiliaries may be used in appropriate amounts depending on the intended use as known in the art. Examples of typical amounts of individual or total amounts of auxiliaries include from 0.1 wt. % to 50 wt. % based on the total weight of rubber in the compound.

For making the rubber compounds the partially hydrogenated polymer or the polymer composition according to the present disclosure can be blended with one or more of ingredients by means as known in the art of rubber processing, for example by using rolls, internal mixers and mixing extruders. The fillers are preferably admixed to the solid partially hydrogenated butadiene polymer or to a mixture of it with other rubbers as known in the art, for example by using a kneader. Fillers may be added as solids, or as slurry or otherwise as known in the art.

### Vulcanizates

Rubber vulcanizates are obtainable by subjecting the rubber compounds of the present disclosure to one or more curing steps. Curing can be carried out as known in the art. Curing is commonly carried out at temperatures between 100 to 200° C., for example between 130 to 180° C. Curing may be carried out in molds under pressure. Typical pressures include pressures of 10 to 200 bar. Curing times and conditions depend on the actual composition of rubber compounds and the amounts and types of curatives and curable components.

### Articles

The compositions and compounds according to the present disclosure can be used to make articles and are particularly suitable for making tires or components of tires. The tires include pneumatic tires. The tires include tires for motor vehicles, aircrafts and electro vehicles and hybrid vehicles, i.e. vehicles that can be driven by a combustion engine or an electro engine or batteries. Typical components of tires include inner liner, treads, undertreads, carcass, and the sidewalls.

In one embodiment the compositions according to the present disclosure are used as a sealing material, for example for making O-rings, gasket or any other seal or component of seals.

In one embodiment the compositions according to the present disclosure are used as impact modifiers for thermoplastics including polystyrenes and styrene-acrylonitriles.

In another embodiment the compositions according to the present disclosure are used for making golf balls or components thereof.

In another embodiment the composition according to the present disclosure is used to make shaped articles selected from profiles, membranes, damping elements and hoses.

The articles may be obtained by subjecting the curable rubber compound of the present disclosure to curing and shaping. The shaping step may take place during or after the curing step or also prior to curing step. A single curing and/or shaping step may be used or a plurality of curing and/or shaping steps may be used. During curing or shaping or both to form articles the compositions and compounds of the present disclosure can be combined with one or more additional ingredients needed for making the article.

In the following the present disclosure is further illustrated by particular embodiments and examples without, however, intending to limit the present disclosure to these specific embodiments and examples.

### Methods

### Polymer Properties

Hydrogenation degree:

The hydrogenation degree describes the ratio of hydrogenated double bonds to non-hydrogenated double bonds in the diene polymer according to formula 1.1 and 1.2:

$$Hydrogenation degree = \frac{{n}_{hydrogenated double bonds}}{{n}_{double bonds of non - hydrogenated polymer}} \qquad ( 1.1 )$$

$$Hydrogenation degree = \frac{{n}_{hydrogenated double bonds}}{{n}_{remaining double bonds} + {n}_{hydrogenated double bonds}} \qquad ( 1.2 )$$

The hydrogenation degree can be determined by ¹H NMR spectroscopy. The amount of double bonds present in the polymer can be obtained by the integral from the olefinic protons in the region from 4.7 to 5.8 ppm in the ¹H NMR spectrum. As the signal represents two protons per diene unit, the integral needs to be divided by two (formula 1.3):

$${n}_{remaining double bonds} = \frac{{i}_{4.7 - 5.8 ppm}}{2} \qquad ( 1.3 )$$

By hydrogenation of the double bond saturation takes place and two new protons are added. This leads to shifting of eight protons (per butadiene unit) to 1.1 to 1.5 ppm in the ¹H NMR spectrum. Consequently, the integral in this region represents the hydrogenated double bonds divided by 8 (formula 1.4).

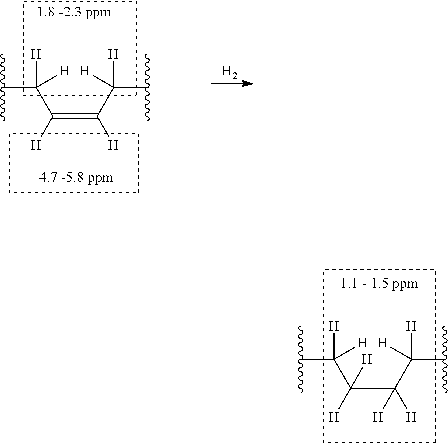 [SMILES: *C/C=C\C* ; "H2" ; *CCCC*]

$${n}_{hydrogenated double bonds} = \frac{{i}_{1.1 - 1.5 ppm}}{8} \qquad ( 1.4 )$$

Therefore, the hydrogenation degree can be determined by the ratio of these integrals in the ¹H NMR spectrum according to formula 1.5:

$$Hydrogenation degree = \frac{\frac{{i}_{1.1 - 1.5 ppm}}{8}}{\frac{{i}_{4.7 - 5.8 ppm}}{2} + \frac{{i}_{1.1 - 1.5 ppm}}{8}} = \frac{{i}_{1.1 - 1.5 ppm}}{4 \cdot {i}_{4.7 - 5.8 ppm} + {i}_{1.1 - 1.5 ppm}} \qquad ( 1.5 )$$

The hydrogenation degree is expressed as %, i.e. the result of equation (1.5) is multiplied with 100%. For example, a ratio of 0.2 as a result of the equation according to 1.5 corresponds to a hydrogenation degree of 20%.

Content of cis, trans and vinyl units:

The content of vinyl, cis and trans units in the polymer can be determined by FT-IR spectrometry using the absorbances and absorbance ratios as described in the standard ISO 12965:2000(E).

Mooney viscosity:

The Mooney viscosity of the polymer was determined according to the standard ASTM D1646 (1999) using a 1999 Alpha Technologies MV 2000 Mooney viscometer.

Mooney stress relaxation (MSR):

Mooney Stress Relaxation (MSR) was determined in according to ASTM D 1646-00 at a temperature of 100° C.

Molecular weight and weight distribution:

Molecular weight (number averaged molecular weight (Mn), the weight averaged molecular weight (Mw)) and the molecular weight distribution (Mw/Mn)) were determined by gel permeation chromatography (GPC). A modular system from Agilent, Santa Clara, CA, USA was used comprising an Agilent 1260 Refractive Index Detector, Agilent 1260 Variable Wavelength Detector, 1260 ALS autosampler, column oven (Agilent 1260 TCC), Agilent 1200 Degasser, Agilent 1100 Iso Pump and a column combination of 3 PLgel 10 μm Mixed B300×7.5 mm columns from Agilent. Tetrahydrofuran (THF) was used as solvent. Polystyrene standards from PSS Polymer Standards Service GmbH (Mainz, Germany) were used. The polymer samples dissolved in THF were filtered through syringe filters (0.45 μm PTFE membranes, diameter 25 mm). The measurements were conducted at 40 ° C. and with a flow rate of 1 mL/min.

Glass transition temperature:

The glass transition temperatures (Tg) was determined by differential thermoanalysis (DTA, differential scanning calorimetry (DSC)) on a 2003 Perkin Elmer DSC-7 calorimeter. 10 mg to 12 mg of the polymer were place on a DSC sample holder (standard aluminum pan) from Perkin Elmer. Two cooling/heating cycles were conducted and the Tg was determined in the second heating cycle. The first DSC cycle was conducted by first cooling the sample down to −100° C. with liquid nitrogen and then heating it up to +150° C. ata rate of 20 K/min. The second DSC cycle was commenced by cooling of the sample as soon as a sample temperature of +150° C. had been reached at a cooling rate of about 320 K/min. In the second heating cycle, the sample was heated up again to +150° C. at a heating rate of 20 K/min. The Tg was determined from the graph of the DSC curve of the second heating operation.

Content of polymer-bound sulfur:

1 g polymer sample was cut into smaller pieces and extracted by Soxhlet extraction with 50 mL of acetone (>99% purity) under reflux for 48 hours. After extraction the polymer was dried at 60 ° C. in a vacuum oven. The subsequent quantification of the sulfur amount (bound sulfur) was conducted via Combustion Ion Chromatography (CIC), The CIC technique consists of two coupled units: one is an automated digestion unit consisting of an autosampler, a combustion unit (electric heater) and an absorption module; the second is an Ion Chromatography unit for quantification. For the measurement the polymer sample is weighed into a ceramic boat and is then pyrohydrolytically oxidized in an argon-oxygen atmosphere. The analyte gases are then absorbed in a hydrogen peroxide solution and automatically transferred to the ion chromatograph, where sulfur is measured as sulfate anion. CIC machines are commercially available, for example, from Thermo Fisher Scientific (for example Fisher Scientific GmbH, Schwerte, Germany).

### Properties of Curable Compounds

Mooney viscosity:

The Mooney viscosity (measuring conditions ML (1+4) at 100° C.) of the curable compounds was determined according to ISO 289-1 on an Alpha Technology Mooney MV 2000, from 1999.

Monsanto MDR:

The Monsanto MDR was determined according to ISO 6502 on an Alpha Technology Rheometer MDR 2000 E.

### Properties of Vulcanized Polymers

Hardness:

Shore A hardness at 60° C. was determined according to DIN 53505.

Rebound resilience:

Rebound resilience at 60° C. was determined according to DIN 53512.

Mechanical Stress: Stress values at 10%, 100% and 300% elongation (a10, a100 and a300), tensile strength and elongation at break were determined according to DIN 53504 on an S2 test device at 10 kN on a roboTest R robotic test system from ZwickRoelln, Ulm, Germany.

Abrasion:

Abrasion was determined according to DIN 53516.

Dynamic properties:

Dynamic properties were determined according to DIN53513-1990 on Eplexor 500 N from Gabo-Testanlagen GmbH, Ahlden, Germany at 10 Hz in the temperature range from −100° C. to +100° C. at a heating rate of 1 K/min (Sample: strips with l*w*t =60 mm*10 mm*2 mm; free length between sample holder 30 mm). The following properties were determined this way: E′ (60° C.): storage modulus at 60° C.; E′ (23° C.): storage modulus at 23° C.; E′ (0° C.): storage modulus at 0° C.; tan δ (60° C.), i.e. the loss factor (E″/E′) at 60° C.; tan δ (23° C.), i.e., the loss factor (E″/E′) at 23° C. and tan δ (0° C.), i.e. the loss factor (E″/E′) at 0° C. E′ provides an Indication of the grip of a winter tire tread on ice and snow. As E′ decreases, grip improves. tan δ (60° C.) is a measure of hysteresis loss from the tire under operating conditions. As tan δ (60° C.) decreases, the rolling resistance of the tire decreases. tan δ (0° C.) is a measure for the wet grip of the material. As tan δ (0° C.) increases the wet grip increases.

Elastic Properties:

Elastic properties were determined according to DIN53513-1990. An elastomer test system (MTS Systems GmbH, 831 Elastomer Test System) was used. The measurements were carried out in double shear mode with no static pre-strain in shear direction and oscillation around 0 on cylindrical samples (2 samples each 20×6 mm, pre-compressed to 5 mm thickness) and a measurement frequency of 10 Hz in the strain range from 0.1 to 40%. The method was used to obtain the following properties: G′ (0.5%): dynamic modulus at 0.5% amplitude sweep, G′ (15%): dynamic modulus at 15% amplitude sweep, G′ =G′ (0.5%)−G′ (15%): difference of dynamic modulus at 0.5% relative to 15% amplitude sweep, tan δ (max): maximum loss factor (G″/G′) of entire measuring range at 60° C.

The difference of G′ (0.5%)−G′ (15%) is an indication of the Payne effect of the mixture. The lower the value the better the distribution of the filler in the mixture, the better the rubber-filler interaction and the lower the risk of phase separation. Tan δ (max) is another measure of the hysteresis loss from the tire under operating conditions. As tan δ (max) decreases, the rolling resistance of the tire decreases.

### EXAMPLES

General polymerization and hydrogenation:

Polybutadiene polymers were prepared by solution polymerization of 1,3-butadiene in the presence of a Ziegler Natta type neodymium catalyst. The polybutadiene polymers had a high cis content of greater than 95% by weight based on the total weight of the polymer and a vinyl content of less than 0.94% by weight and a trans content of less of 4% or less, based on the total weight of the polymer. The polymers had the same Mooney viscosity but differed in their molecular weight distribution, molecular weight and Mooney stress relaxation as the result of treatment of the reaction mixture with a sulfur-containing modifier. The first polymer (comparative exp. 1) contained less than 100 ppm of bound sulfur (as measured after extraction) and the second polymer (comparative exp. 2) contained between 100 and 1000 ppm of bound sulfur. The polymers had a gel content of about 1% by weight. These polymers were used as starting polymers and their properties are summarized in table 1. Portions of these polymers were subjected to partial hydrogenation to different degrees of hydrogenation (examples 1 to 5, exp. 1-5). The hydrogenation was carried out following essentially the procedure described in US2019284374 A1 to Salem et al, which is incorporated herein by reference, under the heading “Procedure for Hydrogenations”. This reference describes the hydrogenation for acrylonitrile rubber, but the procedure was applied for the partial hydrogenation of the polybutadienes accordingly. The properties of the partially hydrogenated polymers are shown in table 1.

TABLE 1
properties of the polymers

| | HD * | MV** | | Mn | Mw | | Tg |
|---|---|---|---|---|---|---|---|
| | [mol %] | [MU] | MSR | [kg/mol] | [kg/mol] | MWD*** | [° C.] |
| Com- | 0 | 45 | 0.64 | 253 | 635 | 2.5 | −104 |
| parative | | | | | | | |
| Exp 1 | | | | | | | |
| Com- | 0 | 45 | 0.48 | 241 | 650 | 2.8 | −104 |
| parative | | | | | | | |
| Exp 2 | | | | | | | |
| Exp 1 | 23 | 79 | 0.52 | n.d. | n.d. | n.d. | −102 |
| Exp 2 | 46 | 96 | 0.49 | 211 | 566 | 2.68 | −72 |
| Exp 3 | 9 | 63 | 0.36 | 152 | 504 | 3.31 | −103 |
| Exp 4 | 19 | 77 | 0.59 | 149 | 554 | 3.72 | −96 |
| Exp 5 | 40 | 127 | 0.58 | 126 | 531 | 4.20 | −77 |

* HD = hydrogenation degree;
**MV = Mooney viscosity;
***MWD = molecular weight distribution;
n.d. = not determined.

Compound preparation:

The polymers of comparative examples 1 and 2 and examples 1 to 5 were compounded with the ingredients listed in table 2 by subsequently adding and mixing the ingredients in a 1.5 L kneader (Werner & Pfleiderer GK 1,5 E) within a period of 150 seconds. Then two rounds of kneading were carried out at 150° C. for 3 minutes each interrupted by a resting period at room temperature for 24 hours. Sulfur and accelerator were not introduced into the kneader but were subsequently admixed on a roll mill (4 mm nip, at 40° C.).

TABLE 2

| | | |
|---|---|---|
| Polybutadiene | Polymers of examples 1 to 5 and comparative | 30 |
| rubbers | examples 1 to 2 | |
| Buna ® VSL4562-2HM | Styrene-butadiene copolymer; ARLANXEO | 96.4 |
| | Deutschland GmbH | |
| VULCAN J/N375 | Carbon black; Cabot GmbH | 5 |
| ULTRASIL 7000 GR | Silica; Evonik | 90 |
| VIVATEC 500 | TDAE oil; Hansen & Rosenthal GmbH | 4.6 |
| EDENOR C 18 98- | Stearic acid; Caldic Deutschland GmbH | 2.5 |
| 100 | | |
| VULKANOX 4020/LG | Stabilizer; Lanxess Deutschland GmbH | 2 |
| VULKANOX HS/LG | Stabilizer; Lanxess Deutschland GmbH | 2 |
| ZINKWEISS | Zinc oxide; Grillo Zinkoxid GmbH | 3 |
| ROTSIEGEL | | |
| ANTILUX 654 | Light protection wax; Lanxess Deutschland GmbH | 2 |
| SI 69 | Bifunctional sulfur-containing silane; Evonik | 7.2 |
| RHENOGRAN IS 90- | Sulfur curing agent; Lanxess Deutschland GmbH | 2.46 |
| 65 | | |
| RHENOGRAN DPG- | Guanidin-based accelerator; Lanxess Deutschland | 2.75 |
| 80 | GmbH | |
| EDENOR C 18 98- | Stearic acid; Emery Oleochemicals GmbH | 2.5 |
| 100 | | |
| RHENOGRAN TBBS- | N-tert-butyl-2-benzothiazyl sulfenamide (80%), | 2 |
| 80 | accelerator; Lanxess Deutschland GmbH. | |

The resulting curable compounds were analyzed for mechanical and dynamical properties. Portions of the curable compounds were vulcanized (cured) in a mold at 160° C. and 120 bar for 20 minutes. The properties of the curable and cured compounds are shown in tables 3, 4 and 5.

TABLE 3
properties of the compounds

| Compound made with the | Comparative | Comparative | | | | | |
|---|---|---|---|---|---|---|---|
| polymer of | Exp 1 | Epx 2 | Exp 1 | Exp 2 | Exp 3 | Exp 4 | Exp 5 |
| Properties | | | | | | | |
| ML(1 + 4)100° C. [MU] | 79 | 78 | 118 | * | 97 | 138 | * |
| Curing MDR @ 160° C. | | | | | | | |
| Delta S′ [dNm] | 15.28 | 15.48 | 16.16 | 17.56 | 14.98 | 16.24 | 16.72 |
| t95% [sec] | 1375 | 1523 | 2254 | 2159 | 1837 | 2093 | 2214 |

* not determined at settings 1 + 4, 100° C.

TABLE 4
Properties of the vulcanizates.

| | Comparative | Comparative | | | | | |
|---|---|---|---|---|---|---|---|
| | Exp 1 | Exp 2 | Exp 1 | Exp 2 | Exp 3 | Exp 4 | Exp 5 |
| Temperature Sweep | | | | | | | |
| (0.9% +/− 0.1%, 10 Hz) | | | | | | | |
| tan d (0° C.) | 0.315 | 0.312 | 0.393 | 0.388 | 0.326 | 0.34 | 0.397 |
| tan d (23° C.) | 0.178 | 0.181 | 0.182 | 0.164 | 0.162 | 0.153 | 0.157 |
| tan d (60° C.) | 0.094 | 0.097 | 0.089 | 0.075 | 0.079 | 0.071 | 0.069 |
| E′ (23° C.) [MPa] | 14.75 | 15.54 | 13.88 | 15.71 | 11.31 | 11.66 | 12.51 |
| Amplitude Sweep | | | | | | | |
| (60° C., 10 Hz) | | | | | | | |
| G′(0.5%) [MPa] | 2.99 | 3.06 | 2.92 | 2.97 | 2.41 | 2.35 | 2.6 |
| G′(15%) [MPa] | 1.36 | 1.35 | 1.45 | 1.59 | 1.29 | 1.39 | 1.54 |
| G′(0.5%) − G′(15%) [MPa] | 1.63 | 1.71 | 1.47 | 1.38 | 1.12 | 0.96 | 1.06 |
| tan d (max) | 0.17 | 0.181 | 0.156 | 0.138 | 0.146 | 0.129 | 0.128 |

TABLE 5
Properties of the vulcanizates (continued).

| | Comparative | Comparative | | | | | |
|---|---|---|---|---|---|---|---|
| | Exp 1 | Exp 2 | Exp 1 | Exp 2 | Exp 3 | Exp 4 | Exp 5 |
| Tensile measurement @ 23° C. | | | | | | | |
| S100 [MPa] | 2.5 | 2.6 | 3.5 | 5.5 | 3 | 3.9 | 4.8 |
| S150 [MPa] | 4.67 | 4.66 | 6.59 | 11.76 | 5.38 | 8 | 9.53 |
| S200 [MPa] | 7.81 | 7.73 | 10.99 | n.d. | 9.3 | 13.7 | n.d. |
| D Median [%] | 383 | 358 | 212 | 181 | 290 | 226 | 198 |
| F Median [MPa] | 21.7 | 19.9 | 12.2 | 15.5 | 18.4 | 16.5 1 | 16.6 |
| S150/S100 | 1.87 | 1.79 | 1.88 | 2.14 | 1.79 | 2.05 | 1.99 |
| Rebound at 23° C. [%] | 35.6 | 34.2 | 32.27 | 35.2 | 38.73 | 40.33 | 37.8 |
| Rebound at 60° C. [%] | 57 | 57 | 58 | 62 | 61 | 64 | 64 |
| Hardness at 23° C. [Shore A] | 65 | 64 | 71 | 72 | 64 | 68 | 72 |

n.d. = not determined

The results in tables 3 to 5 demonstrate that partial hydrogenation of the polymers improves their properties. The rebound properties at 60° C. improve with increasing hydrogenation degrees but appear to reach a plateau at higher hydrogenation degrees. The tan δ (60° C.) values decrease with increasing hydrogenation degrees which indicates reduced rolling resistance with increasing hydrogenation. The tan δ (0° C.) values increase with increasing hydrogenation indicating increased wet grip of the material. The difference G′(0.5%)−G′(15%) decreased with increasing hydrogenation. This difference is an indication of the Payne effect (rubber-filler interaction). The smaller the difference the better is the distribution of the filler in the mixture, the better the rubber-filler interaction and the lower the risk of phase separation. This shows that the rubber-filler interactions in the compound improve and the risk of phase separation is reduced. This effect is surprising because polar groups (unsaturated groups) were removed by the hydrogenation. The improvement plateaus at high hydrogenation degrees.

The Mooney viscosity of the polymers increases with increasing hydrogenation degrees. At a hydrogenation degree above 39% the Mooney viscosity becomes too high to be measured at measuring conditions ML(1+4) at 100° C. and different measuring conditions may have to be used. At a hydrogenation degree of 55% or above the improvement of the dynamic mechanical properties may be offset by high Mooney viscosities which make compound processing very difficult. By increasing molecular weight or molecular weight distribution of the polymers or by lowering Mooney stress relaxation of the polymers, the properties already improve at a lower hydrogenation degree and thus at lower Mooney viscosities.

### Examples with Polymer Blends

Rubber compounds with blends of the polymer according to the present disclosure with different functionalized polymers were prepared (Exp 6 to 10). In comparative examples (Comp Exp 3 to 5) rubber compounds with blends of non-hydrogenated diene polymer with functionalized polymers were prepared for comparison. The polymer compositions are shown in table 6, the ingredients for making the rubber compounds are shown in table 7.

The amounts were adapted to arrive at compounds with similar hardness. The rubber compounds were subjected to curing and the results are shown in table 8. As can be seen from table 8 the compounds became stiffer due to the reduced amounts of C-C double bonds and the dispersion with fillers improved as evidenced by better dynamic properties (lower tan delta max and improved rebound at 60° C.).

TABLE 6
polymer compositions

| | HD* | Mn | Mw | Tg | MV | |
|---|---|---|---|---|---|---|
| Type | [mol %] | [kg/mol] | [kg/mol] | [° C.] | [MU] | Functionalization |
| Polymer 1: | 0 | 230 | 580 | −104 | 43 | none |
| Polybutadiene, not treated | | | | | | |
| with sulfur modifier; gel | | | | | | |
| content of 0.7 wt %; | | | | | | |
| MSR of 0.644 | | | | | | |
| Polymer 2: | 20 | 289 | 583 | −96 | 90 | none |
| hydrogenated version of | | | | | | |
| polymer 1; MSR of 0.678 | | | | | | |
| Polymer 3 | 0 | | | | | none |
| styrene-butadiene | | | | | | |
| Polymer 4: | 0 | 297 | 705 | −23 | | ω-functionalized |
| functionalized styrene- | | | | | | |
| butadiene (21 wt % styrene) | | | | | | |
| generally described in: | | | | | | |
| US2016/0083495A1 and | | | | | | |
| US2016/0075809A1 | | | | | | |
| Polymer 5: | 0 | 273 | 350 | | 93 | α- and ω- |
| functionalized styrene- | | | | | | functionalized |
| butadiene (21 wt % styrene); | | | | | | |
| MSR of 1.208, generally | | | | | | |
| described in: | | | | | | |
| EP2847264A1 | | | | | | |
| Polymer 6: | 0 | 340 | 623 | −24 | 123 | in-chain |
| functionalized styrene- | | | | | | functionalized |
| butadiene (26 wt % styrene); | | | | | | |
| MSR of 0.457 | | | | | | |
| Polymer 7: | 0 | 324 | 446 | −26 | 66 | ω-functionalized |
| functionalized styrene- | | | | | | |
| butadiene (21 wt % styrene); | | | | | | |

*HD = hydrogenation degree;

TABLE 7
compound ingredients

| | Comp | | | | | | Comp | Comp |
|---|---|---|---|---|---|---|---|---|
| | Exp 3 | Exp 6 | Exp 7 | Exp 8 | Exp 9 | Exp 10 | Exp 4 | Exp 5 |
| VULCAN | 5 | 5 | 5 | 5 | 5 | 5 | 5 | 5 |
| J/N375 | | | | | | | | |
| ULTRASIL | 90 | 75 | 75 | 75 | 75 | 75 | 90 | 90 |
| 7000 GR | | | | | | | | |
| VIVATEC 500 | 4.6 | 4.6 | 27.3 | 30.9 | 30.9 | 30.9 | 27.3 | 30.9 |
| PALMERA A | 2.5 | 2.5 | 2.5 | 2.5 | 2.5 | 2.5 | 2.5 | 2.5 |
| 9818 | | | | | | | | |
| VULKANOX | 2 | 2 | 2 | 2 | 2 | 2 | 2 | 2 |
| 4020/LG | | | | | | | | |
| VULKANOX | 2 | 2 | 2 | 2 | 2 | 2 | 2 | 2 |
| HS/LG | | | | | | | | |
| RHENOGRAN | 2.75 | 2.75 | 2.75 | 2.75 | 2.75 | 2.75 | 2.75 | 2.75 |
| DPG-80 | | | | | | | | |
| ANTILUX 654 | 2 | 2 | 2 | 2 | 2 | 2 | 2 | 2 |
| SI 69 | 7.2 | 6 | 6 | 6 | 6 | 6 | 7.2 | 7.2 |
| ZINKOXID | 3 | 3 | 3 | 3 | 3 | 3 | 3 | 3 |
| ROTSIEGEL | | | | | | | | |
| RHENOGRAN | 2.46 | 1.85 | 1.85 | 1.85 | 1.85 | 1.85 | 2.46 | 2.46 |
| IS 90-65 | | | | | | | | |
| RHENOGRAN | 2 | 1.5 | 1.5 | 1.5 | 1.5 | 1.5 | 2 | 2 |
| TBBS-80 | | | | | | | | |
| Polymer 1 | 30 | | | | | | 30 | 30 |
| Polymer 2 | | 30 | 30 | 30 | 30 | 30 | | |
| Polymer 3 | 96.4 | 96.4 | | | | | | |
| Polymer 4 | | | 75 | | | | 75 | |
| Polymer 5 | | | | 70 | | | | |
| Polymer 6 | | | | | 70 | | | |
| Polymer 7 | | | | | | 70 | | 70 |

TABLE 8
compound properties

| | Comp | | | | | | Comp | Comp |
|---|---|---|---|---|---|---|---|---|
| Properties | Exp 3 | Exp 6 | Exp 7 | Exp 8 | Exp 9 | Exp 10 | Exp 4 | Exp 5 |
| ML(1 + 4) at 125° C./ | 70.99 | 143.22 | 143.22 | 153.75 | — | 137.59 | 73.35 | 62.33 |
| MU | | | | | | | | |
| Curing MDR at | | | | | | | | |
| 160° C. | | | | | | | | |
| Delta S′/dNm | 14 | 11 | 11 | 11 | 11 | 11 | 14 | 13 |
| t95%/sec | 1631 | 2303 | 2387 | 2695 | 2095 | 2366 | 1515 | 1544 |
| Vulcanizate | | | | | | | | |
| Properties | | | | | | | | |
| tan d (0° C.) | 0.378 | 0.397 | 0.356 | 0.357 | 0.297 | 0.308 | 0.361 | 0.329 |
| tan d (23° C.) | 0.177 | 0.143 | 0.139 | 0.126 | 0.127 | 0.123 | 0.17 | 0.143 |
| tan d (60° C.) | 0.081 | 0.072 | 0.072 | 0.063 | 0.071 | 0.072 | 0.086 | 0.073 |
| E′ 23° C./MPa | 10.2 | 7.2 | 7.5 | 7.9 | 7.9 | 6.7 | 9.4 | 6.9 |
| tan d (0° C.)/tan d | 4.7 | 5.5 | 4.9 | 5.7 | 4.2 | 4.3 | 4.2 | 4.5 |
| (60° C.) | | | | | | | | |
| Amplitude Sweep | | | | | | | | |
| (60° C., 10 Hz) | | | | | | | | |
| G′(0.5%)/MPa | 2.4 | 1.6 | 1.7 | 1.6 | 1.6 | 1.5 | 2.6 | 2.2 |
| G′(15%)/MPa | 1.2 | 1.1 | 1.2 | 1.2 | 1.2 | 1.1 | 1.3 | 1.2 |
| G′(0.5%) − G′(15%)/ | 1.2 | 0.5 | 0.5 | 0.5 | 0.4 | 0.3 | 1.3 | 1.0 |
| MPa | | | | | | | | |
| tan d max | 0.168 | 0.121 | 0.123 | 0.118 | 0.109 | 0.108 | 0.201 | 0.185 |
| Tensile | | | | | | | | |
| measurements | | | | | | | | |
| (23° C.) | | | | | | | | |
| S100/MPa | 3 | 4 | 4 | 4 | 4 | 3 | 3 | 3 |
| S200/MPa | 8 | 1 | | 11 | 12 | 11 | 8 | 8 |
| D Median/% | 353 | 251 | 245 | 278 | 240 | 251 | 329 | 357 |
| F Median/MPa | 21 | 17 | 16 | 17 | 17 | 15 | 19 | 21 |
| Rebound 23° C./% | 35 | 46 | 48 | 49 | 52 | 51 | 39 | 43 |
| Rebound 60° C./% | 58 | 68 | 68 | 68 | 70 | 69 | 61 | 63 |
| Hardness/Shore A | 63 | 62 | 62 | 61 | 66 | 61 | 61 | 59 |

### Example 11 and Comparative Example 4.

In Example 11 a combination the hydrogenated diene rubber according to the present disclosure (polymer 2 above) and the non-functionalized styrene-butadiene polymer (polymer 3 above) was used to produce a rubber compound. In Comparative Example 4 a compound was made with the combination of a non-hydrogenated diene polymer (polymer 1 above) and the same non-functionalized butadiene-styrene polymer, however the amounts of curatives were higher than in Example 11. The ingredients for making the compounds are shown in table 9. The properties of the cured compounds are shown in table 10. As can be seen from table 10 although less curatives were used in Example 11 similar mechanical and dynamic properties were obtained as with Comparative Example 4 but the abrasion value of Example 11 was better.

TABLE 9
Compound compositions.

| | Comp Exp 4 | Exp 11 |
|---|---|---|
| VULCAN J/N375 | 5 | 5 |
| ULTRASIL 7000 GR | 90 | 90 |
| VIVATEC 500 | 4.6 | 4.6 |
| PALMERA A 9818 | 2.5 | 2.5 |
| VULKANOX 4020/LG | 2 | 2 |
| VULKANOX HS/LG | 2 | 2 |
| RHENOGRAN DPG-80 | 2.75 | 2.06 |
| ANTILUX 654 | 2 | 2 |
| SI 69 | 7.2 | 7.2 |
| ZINKOXID ROTSIEGEL | 3 | 2.25 |
| RHENOGRAN IS 90-65 | 2.46 | 1.85 |
| RHENOGRAN TBBS-80 | 2 | 1.5 |
| Polymer 1 | 30 | |
| Polymer 2 | | 30 |
| Polymer 3 | 96.4 | 96.4 |

TABLE 10
Compound properties.

| | Comp Exp 4 | Exp 11 |
|---|---|---|
| Properties | | |
| ML(1 + 4) at 125° C./MU | 77 | — |
| Curing MDR at 160° C. | | |
| Delta S′/dNm | 14 | 13 |
| t95%/sec | 1720 | 2650 |
| Vulcanizate Properties | | |
| tan d (0° C.) | 0.32 | 0.37 |
| tan d (23° C.) | 0.19 | 0.16 |
| tan d (60° C.) | 0.1 | 0.1 |
| E′ 23° C./MPa | 17 | 14 |
| tan d (0° C.)/tan d (60° C.) | 3.2 | 4.3 |
| Amplitude Sweep (60° C., 10 Hz) | | |
| G′(0.5%)/MPa | 2.53 | 2.14 |
| G′(15%)/MPa | 1.24 | 1.33 |
| G′(0.5%) − G′(15%)/MPa | 1.29 | 0.81 |
| tan d max | 0.175 | 0.139 |
| Tensile measurements at 23° C. | | |
| S100/MPa | 2.4 | 3.9 |
| S200/MPa | 4.2 | 7.8 |
| D Median/% | 377 | 255 |
| F Median/MPa | 21 | 19 |
| Rebound 23° C./% | 34 | 40 |
| Rebound 60° C./% | 56 | 63 |
| Abrasion/mm³ | 87 | 69 |
| Hardness/Shore A | 62 | 69 |

1. A curable, partially hydrogenated butadiene polymer having a hydrogenation degree from 0.5 to 55% and having a total amount of butadiene-derived vinyl groups according to the general formula (I) 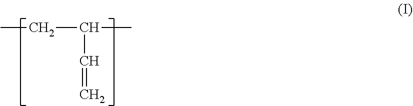
and trans groups of the general formula (II) 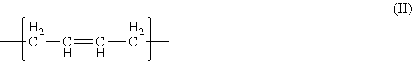
of 0 to 9% by weight based on the total weight of the polymer and wherein the partially hydrogenated polybutadiene polymer is a butadiene polymer comprising at least 50% by weight based on the total weight of the polymer which is 100%, of units derived from 1,3-butadiene.

2. The partially hydrogenated polymer of claim 1 having no or less than 0.94% by weight based on the total weight of the polymer of butadiene-derived vinyl units according to formula (I).

3. The partially hydrogenated polymer of claims 1 having from 0 to 8% by weight based on the total weight of the polymer of butadiene-derived trans units according to formula (II).

4. The partially hydrogenated polymer of claim 1 containing units derived from one or more comonomer selected from conjugated dienes having from 5 to 20 carbon atoms other than 1,3-butadiene, wherein at least some of the units derived from the one or more comonomers may be present in hydrogenated or partially hydrogenated form.

5. The partially hydrogenated polymer of claim 1 containing at least 80% by weight of units derived from 1,3-butadiene and having a hydrogenation degree of from 2 to 39%.

6. The partially hydrogenated polymer of claim 1 having a weight average molecular weight (Mw) of from 100,000 to 2,500,000 g/mole and a molecular weight distribution (Mw/Mn) of from 1.5 to 15 and a glass transition temperature of from −120 to 0° C.

7. The partially hydrogenated polymer of claim 1 having a content of bound sulfur as measured by extraction of from 12 ppm to 20,000 ppm or from 20 ppm to 2,000 ppm based on the total weight of the polymer.

8. A composition comprising from 90% to 100% by weight based on the total weight of the composition of at least one partially hydrogenated butadiene polymer according to claim 1.

9. The composition of claim 8 having a Mooney viscosity ML 1+4 at 100° C. of from 40 to 130.

10. A curable compound comprising at least 5% by weight of at least one partially hydrogenated butadiene polymer of claim 1 and at least 10% by weight of one or more filler, wherein the filler is suitable for application in tires, tire components and materials for making tires and contains one or more silicon oxide, one or more carbon blacks or a combination of one or more silicon oxide and one or more carbon black and the percent by weight are based on the total weight of the compound, wherein the compound, optionally,, further comprises at least one diene polymer, wherein the diene polymer is functionalized to contain one or more functional groups comprising a silane unit, a siloxane unit, an aminosiloxane unit, a sulfursiloxane unit, a plurality thereof or a combination thereof.

11. A vulcanizate obtained by curing the curable compound of claim 10.

12. An article comprising the vulcanizate of claim 11.

13. A process of making the partially hydrogenated butadiene polymer according to claim 1 comprising providing at least one curable butadiene polymer as starting polymer and subjecting the starting polymer to at least one hydrogenation treatment to reduce the number of unsaturated units in the polymer and to achieve a hydrogenation degree from 0.5% to 55% or 2% to 39% and to an amount of butadiene-derived vinyl groups according to the general formula (I) 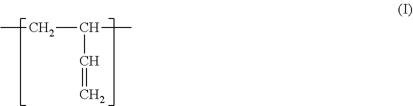
and butadiene-derived trans groups of the general formula (II) 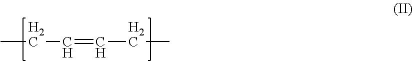
of from 0% to 9% by weight based on the total weight of the polymer, wherein the starting polymer contains at least 50% by weight of units derived from 1,3-butadiene.

14. The process of claim 13, wherein the starting polymer contains from 0 to 0.94% by weight of the vinyl groups and from 0 to 8% by weight of the trans groups.

15. The process of claim 13 wherein the polybutadiene starting polymer has a content of bound sulfur, as determined by extraction, of from about 12 ppm to about 20,000 ppm or from about 20 ppm to about 2,000 ppm based on the total weight of the polymer.

16. A process of making an article comprising subjecting the curable compound of claim 10 to curing and shaping wherein the shaping may take place during or after or prior to the curing.
